(19) United States
(12) Patent Application Publication
(10) Pub. No.: US 2026/0289517 A1
(43) Pub. Date: Sep. 24, 2026

(54) MULTI-USER INTERACTIVE CALENDAR MANAGEMENT METHOD, MEDIUM AND DEVICE BASED ON ARTIFICIAL INTELLIGENCE

(71) Applicant: Shenzhen Zhengqing Technology Co., Ltd., Shenzhen (CN)

(72) Inventor: Hai bin Nie, Shenzhen (CN)

(21) Appl. No.: 19/461,794

(22) Filed: Jan. 28, 2026

(30) Foreign Application Priority Data
Feb. 6, 2025 (CN) 202510132952.7

(51) Int. Cl. G06Q 10/1093; G06F 21/62

(52) U.S. Cl. CPC G06Q 10/1093; G06F 21/6209; G06F 2221/2113; G06F 2221/2141

(57) ABSTRACT

The present application discloses a multi-user interactive calendar management method, medium and device based on artificial intelligence. The method inputs user demand information and user preference information corresponding to each user into a trained first neural network model, and outputs the first calendar itinerary information corresponding to each user; inputs the first calendar itinerary information, constraint information and user association relationship corresponding to each user into a trained second neural network model, and outputs the second calendar itinerary information corresponding to each user, the third calendar itinerary information of other users who have an association relationship with each user, and the total calendar itinerary information. The above scheme can take into account the personalized needs of each user, and the rationality of the itinerary arrangements of each associated user, so that it can meet the collaborative needs among multiple users.

### CROSS REFERENCE TO THE REPLATED APPLICATIONS

This application is based upon and claims priority to a Chinese Patent Application No. 2025101329527, filed on Feb. 6, 2025, the entire contents of which are incorporated herein by reference.

### TECHNICAL FIELD

The present disclosure relates to the field of artificial intelligence, and in particular to a multi-user interactive calendar management method, medium and device based on artificial intelligence.

### BACKGROUND

With the rapid development of information technology and artificial intelligence, the demand for multi-user schedule management is increasing. However, most traditional schedule management tools are limited to individual use and cannot efficiently meet the collaborative needs of multiple users. They also lack personalized recommendation capabilities and cannot provide intelligent support according to user behavior habits and event dynamics.

### SUMMARY

In view of the above problems, the present disclosure provides a multi-user interactive calendar management method, medium and device based on artificial intelligence to solve the problems that existing schedule management tools cannot meet the collaborative needs of multiple users and lack personalized recommendation capabilities.

To achieve the above objectives, in a first aspect, the present application provides a multi-user interactive calendar management method based on artificial intelligence, the method comprising the following steps:
receiving historical schedule data of multiple users, analyzing each of the historical schedule data respectively, and creating a calendar portrait corresponding to each user, wherein the calendar portrait includes user identification information, user preference information, user association relationship and user permission information;
receiving user demand information, inputting the user demand information and the user preference information corresponding to each user into a trained first neural network model, and outputting first calendar itinerary information corresponding to each user;
receiving a constraint information, inputting first calendar itinerary information corresponding to each user, the constraint information, and user association relationship into a trained second neural network model, and outputting second calendar itinerary information corresponding to each user, third calendar itinerary information of other users who have an association relationship with each user, and total calendar itinerary information, wherein the total calendar itinerary information includes the second calendar itinerary information and the third calendar itinerary information;
presenting any one or more of the second calendar itinerary information, the third calendar itinerary information and the total calendar itinerary information according to user permission information corresponding to each user on the user end.

Alternatively, receiving constraint information, inputting the first calendar itinerary information, the constraint information, and user association relationship corresponding to each user into the trained second neural network model comprises:
when the trained second neural network model detects that the first calendar itinerary information of multiple mutually associated users conflicts with the constraint information, determining a first user group and a first itinerary adjustment information according to the conflict content, sending the first itinerary adjustment information to the first user group, receiving feedback information from the first user group regarding the constraint information or the first itinerary adjustment information, adjusting the constraint information or the first calendar itinerary information of at least one user in the first user group based on the feedback information, and determining again whether the first calendar itinerary information of all users conflicts with the constraint information after the adjustment is completed;
repeating above steps until there is no conflict between the first calendar itinerary information of all users and the constraint condition information or until all users in the first user group are traversed.

Alternatively, determining the first user group and the first itinerary adjustment information according to the conflict content, and sending the first itinerary adjustment information to the first user group comprises:
determining a first itinerary optimization problem according to the conflict content, analyzing the first itinerary optimization problem, and determining a first user group according to the itinerary adjustment range, wherein the first user group is a number of users with the smallest itinerary adjustment range;
creating itinerary replacement options according to user preference information of users in the first user group, creating and sending first itinerary adjustment information based on the itinerary replacement options to the first user group.

Alternatively, the method comprises:
recording current conflict content if all users in the first user group have been traversed, but the first calendar itinerary information of all users still conflicts with the constraint information;
adding all user identification information associated with the current conflicting content to a discussion group, and presenting the current conflicting content and the suggested adjustment strategy for the current conflicting content in the discussion.

Alternatively, the user permission information includes a first permission, a second permission or a third permission, the third permission has a higher priority than the second permission, and the second permission has a higher priority than the first permission;
presenting any one or more of the second calendar itinerary information, the third calendar itinerary information and the total calendar itinerary information on the user end according to the user permission information corresponding to each user includes:
when the user permission information is the first permission, presenting the second calendar itinerary information corresponding to the user on the user end;
when the user permission information is the second permission, presenting the second calendar itinerary information or the third calendar itinerary information corresponding to the user on the user end according to the received first itinerary switching instruction;
when the user permission information is the third permission, presenting the second calendar itinerary information or the third calendar itinerary information or the total calendar itinerary information corresponding to the user on the user end according to the received second itinerary switching instruction, and when the total calendar itinerary information is presented on the user end, highlighting the calendar itinerary information corresponding to the current user in the total calendar itinerary information.

Alternatively, the user demand information includes any one or more of personnel quantity information, budget information, time span information, geographic location information, activity theme type information, and activity priority information;

The constraint information includes any one or more of time constraints, resource-related constraints or itinerary theme constraints.

Alternatively, the method further includes:
storing the created total calender itinerary information in a first public storage space of the server end, and storing the created second calendar travel information or third calendar travel information in a second public storage space of the server end;
when receiving a first modification request from the user end, after the permission check of the current user is passed, creating second calendar itinerary copy information based on the second calendar itinerary information, or creating third calendar itinerary copy information based on the third calendar itinerary information, sending the second calendar itinerary copy information or the third calendar itinerary copy information to the user end, and receiving the modified second calendar itinerary copy information or the third calendar itinerary copy information uploaded by the current user end, determining whether there is a conflict in itinerary information of each user in the modified third calendar itinerary copy information, and if not, creating first log information according to the content of this modification and the user identification information initiating the modification;
when a second modification request is received from the user end, after the permission check of the current user is passed, creating a total calendar itinerary copy information based on the total calendar itinerary information, sending the total calendar itinerary copy information to the user end, and receiving the modified second total calendar itinerary copy information uploaded by the current user end, and determining whether there is a conflict in the itinerary information of each user in the modified total calendar itinerary copy information, if not, creating new second calendar itinerary information and new third calendar itinerary information according to the current total calendar itinerary copy information, updating the new second calendar itinerary information and new third calendar itinerary information to the second public storage space of the server end, and creating second log information according to the content of this modification and the user identification information that initiated the modification.

Alternatively, the first neural network model is trained according to the following method comprising:
acquiring a first sample data set, where the first sample data set includes sample user demand information and sample user preference information;
performing data expansion on the first sample data set, and randomly arranging and combining the first sample data in the expanded first sample data set to obtain multiple groups of first test cases;
inputting multiple groups of the first test cases into the first neural network model to be trained for iterative training to obtain a trained first neural network model.

The second neural network model is trained according to the following method comprising:
acquiring a second sample data set, where the second sample data set includes sample user association relationships, sample constraint information, and first calendar itinerary information output by the trained first neural network model;
performing data expansion on the second sample data set, and randomly arranging and combining the second sample data in the expanded second sample data set to obtain multiple groups of second test cases;
inputting multiple groups of the second test cases into the second neural network model to be trained for iterative training to obtain a trained second neural network model.

In a second aspect, the present application provides a computer-readable storage medium having a computer program stored thereon, which, when executed by a processor, implements the multi-user interactive calendar management method based on artificial intelligence as described in the first aspect of the present application.

In a third aspect, the present application provides an electronic device on which a computer program is stored, the electronic device including a processor and a storage medium, wherein the storage medium stores a computer program, and when the computer program is executed by the processor, the multi-user interactive calendar management method based on artificial intelligence as described in the first aspect of the present application is implemented.

Different from the prior art, the above technical solution provides a multi-user interactive calendar management method, medium and device based on artificial intelligence, the method comprising: receiving historical schedule data of multiple users, creating calendar portraits corresponding to each user, the calendar portraits including user identification information, user preference information, user association relationship and user permission information; inputting user demand information and user preference information corresponding to each user into the trained first neural network model, and outputting the first calendar itinerary information corresponding to each user; inputting the first calendar itinerary information, constraint information and user association relationship corresponding to each user into the trained second neural network model, and outputting the second calendar itinerary information corresponding to each user, the third calendar itinerary information of other users who have an association relationship with each user and the total calendar itinerary information, the total calendar itinerary information including the second calendar itinerary information and the third calendar itinerary information. The created second calendar itinerary information and the total calendar itinerary information can not only take into account the personalized needs of each user, but also take into account the rationality of the itinerary arrangements of each associated user, so that it can meet the collaborative needs among multiple users.

The above recitations related to the content of the present disclosure are only a summary of the technical solution of the present disclosure. In order to enable ordinary technicians in the field to more clearly understand the technical solution of the present disclosure, and then implement it according to the text of the specification and the contents recited in the drawings, and in order to make the above-mentioned purpose and other purposes, features and advantages of the present disclosure easier to understand, the following is a description in combination with the specific implementation of the present disclosure and the drawings.

### BRIEF DESCRIPTION OF THE DRAWINGS

The drawings are only used to illustrate the principles, implementations, applications, features and effects of the specific embodiments of the present disclosure and other related contents, and shall not be construed as limiting the present disclosure.

In the drawings of the specification:

FIG. 1 is a first flow chart of a multi-user interactive calendar management method based on artificial intelligence according to a specific embodiment;

FIG. 2 is a second flow chart of a multi-user interactive calendar management method based on artificial intelligence according to a specific embodiment;

FIG. 3 is a third flow chart of a multi-user interactive calendar management method based on artificial intelligence according to a specific embodiment;

FIG. 4 is a fourth flow chart of a multi-user interactive calendar management method based on artificial intelligence according to a specific embodiment;

FIG. 5 is a fifth flow chart of a multi-user interactive calendar management method based on artificial intelligence according to a specific embodiment;

FIG. 6 is a sixth flow chart of a multi-user interactive calendar management method based on artificial intelligence according to a specific embodiment;

FIG. 7 is a seventh flow chart of a multi-user interactive calendar management method based on artificial intelligence according to a specific embodiment;

FIG. 8 is an eighth flow chart of a multi-user interactive calendar management method based on artificial intelligence according to a specific embodiment;

FIG. 9 is a modular schematic diagram of an electronic device according to a specific embodiment;

The reference numerals in the above drawings are described as follows:
10. Electronic device;
101. Processor;
102. Storage medium.

### DETAILED DESCRIPTION OF THE EMBODIMENTS

In order to explain in detail the possible application scenarios, technical principles, specific schemes that can be implemented, and the purposes and effects of the present disclosure, the following is a detailed description in combination with the specific embodiments listed and the accompanying drawings. The embodiments described herein are only used to more clearly illustrate the technical solutions of the present disclosure, and are therefore only used as examples, and cannot be used to limit the protection scope of the present disclosure.

The “embodiment” mentioned herein means that the specific features, structures or characteristics described in conjunction with the embodiment may be included in at least one embodiment of the present disclosure. The word “embodiment” appearing in various places in the specification does not necessarily refer to the same embodiment, nor does it particularly limit its independence or association with other embodiments. In principle, in the present disclosure, as long as there is no technical contradiction or conflict, the various technical features mentioned in each embodiment can be combined in any way to form a corresponding implementable technical solution.

Unless otherwise defined, the technical terms used herein have the same meanings as those generally understood by those skilled in the art to which the present disclosure belongs; the use of relevant terms herein is only for describing specific embodiments and is not intended to limit the present disclosure.

In the description of the present disclosure, the term “and/or” is an expression used to describe the logical relationship between objects, indicating that three relationships may exist, for example, A and/or B, which means: A exists, B exists, and A and B exist at the same time. In addition, the character “/” in this disclosure generally indicates that the objects associated before and after are in a logical relationship of “or”.

In the present disclosure, terms such as “first” and “second” are merely used to distinguish one entity or operation from another entity or operation, and do not necessarily require or imply any actual relationship of quantity, priority or sequence between these entities or operations.

Without further restrictions, in the present disclosure, the words “include”, “comprises”, “has” or other similar expressions used in sentences are intended to cover non-exclusive inclusion. These expressions do not exclude the presence of additional elements in the process, method or product including the elements, so that the process, method or product including a series of elements may include not only those limited elements, but also other elements not explicitly listed, or also include elements inherent to such process, method or product.

In the present disclosure, expressions such as “greater than”, “less than”, “exceed” and the like are understood to exclude the number itself; expressions such as “above”, “below”, “within” and the like are understood to include the number itself. In addition, in the description of the embodiments of the present disclosure, “multiple” means more than two (including two), and similar expressions related to “multiple” are also understood in this way, such as “multiple groups”, “multiple times”, etc., unless otherwise clearly and specifically limited.

In the description of the embodiments of the present disclosure, the space-related expressions used, such as “center”, “longitudinal”, “lateral”, “length”, “width”, “thickness”, “up”, “down”, “front”, “back”, “left”, “right”, “vertical”, “horizontal”, “vertical”, “top”, “bottom”, “inside”, “outside”, “clockwise”, “counterclockwise”, “axial”, “radial”, “circumferential”, etc., indicate the orientation or position relationship based on the orientation or position relationship shown in the specific embodiments or drawings, and are only for the convenience of describing the specific embodiments of the present disclosure or facilitating the reader's understanding, and do not indicate or imply that the referred device or component must have a specific position, a specific orientation, or be constructed or operated in a specific orientation, and therefore cannot be understood as a limitation on the embodiments of the present disclosure.

Unless otherwise expressly specified or limited, in the description of the embodiments of the present disclosure, the terms such as “install”, “connect”, “connect”, “fix”, “set” and the like used should be understood in a broad sense. For example, the “connection” can be a fixed connection, a detachable connection, or an integrated setting; it can be a mechanical connection, an electrical connection, or a communication connection; it can be a direct connection, or an indirect connection through an intermediate medium; it can be the internal connection of two elements or the interaction relationship between two elements. For those skilled in the art of the technical field to which the present disclosure belongs, the specific meanings of the above terms in the embodiments of the present disclosure can be understood according to the specific circumstances.

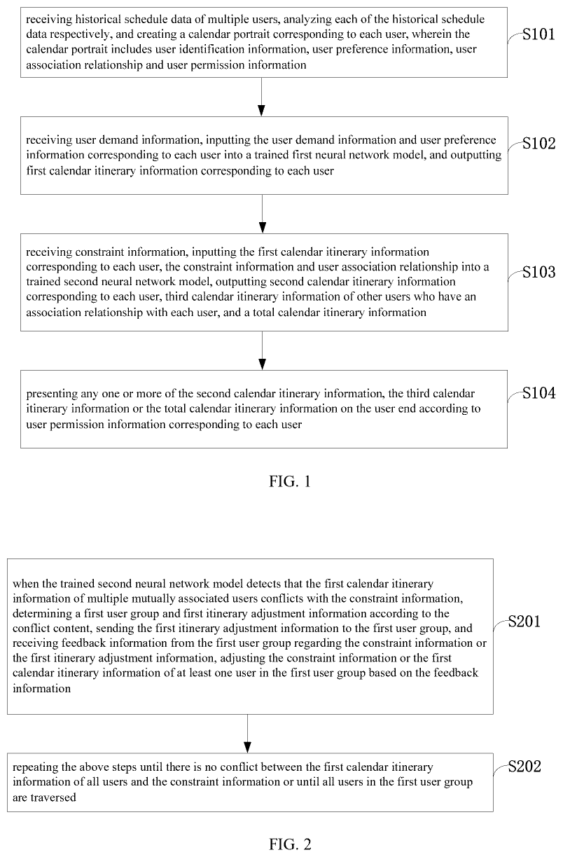

As shown in FIG. 1, in a first aspect, the present application provides a multi-user interactive calendar management method based on artificial intelligence, the method comprising the following steps:

Step S101: receiving historical schedule data of multiple users, analyzing each of the historical schedule data respectively, and creating a calendar portrait corresponding to each user, wherein the calendar portrait includes user identification information, user preference information, user association relationship and user permission information.

In step S101, the historical schedule data generally includes time information and event information, and the event information refers to the tasks that the user needs to perform at a certain time point or in a time period.

Step S102: receiving user demand information, inputting the user demand information and user preference information corresponding to each user into a trained first neural network model, and outputting first calendar itinerary information corresponding to each user.

In step S102, the user demand information can be input through text, voice, importing templates, etc. For example, the user demand information can be a paragraph of text, such as “next week's study schedule, referring to past historical data”. After receiving this paragraph of text, the first neural network model will create the user's study plan schedule (i.e., the first calendar itinerary information) correspondingly for next week based on the user's historical preference information (such as the proportion of previous study plans and rest, distribution of time periods, etc.).

In some embodiments, the user demand information includes any one or more of personnel quantity information, budget information, time span information, geographic location information, activity theme type information, and activity priority information. For example, a user can input by voice “arrange a 2-3 day travel plan in a city, and the itinerary must include at least 2 hours of meeting time every day”, then the first neural network model will take into account the user preference information of each user (such as favorite snacks, favorite activities, etc.) in combination with the characteristics of the city to create a preliminary calendar itinerary for each user, that is, the first calendar itinerary information.

Step S103: receiving constraint information, inputting the first calendar itinerary information corresponding to each user, the constraint information and user association relationship into a trained second neural network model, outputting second calendar itinerary information corresponding to each user, third calendar itinerary information of other users who have an association relationship with each user, and a total calendar itinerary information, wherein the total calendar itinerary information includes the second calendar itinerary information and the third calendar itinerary information.

In some embodiments, the constraint information includes any one or more of time constraints, resource-related constraints or itinerary theme constraints.

For example, when it comes to conference itineraries that require multiple participants, and different users have different budgets and preference information, some users want to rest more, some users want to visit more scenic spots, some users want to visit more cultural landscapes, and some users want to visit more natural scenery, which leads to the need to integrate the first calendar itinerary information of multiple users to ensure that multiple users do not conflict in time when completing some common itineraries, and also take into account the personal preferences of each user as much as possible. Therefore, the second neural network model may create corresponding adjustment factors based on the constraint information and the first calendar itinerary information. The adjustment factors may adjust the time sequence and itinerary content of some user itineraries (preferably the replacement of the same itinerary theme). Then, the first calendar itinerary information of each user is adjusted based on the adjustment factors to obtain the second calendar itinerary information, the third calendar itinerary information and the total calendar itinerary information corresponding to each user.

Step S104: presenting any one or more of the second calendar itinerary information, the third calendar itinerary information or the total calendar itinerary information on the user end according to user permission information corresponding to each user.

The above scheme first creates a user portrait of each user based on the historical schedule data of each user, and then creates a preliminary itinerary arrangement for each user based on user demand information and user preferences, and then selects a part of users based on the association relationship of each user's actions (such as corporate team building, family travel, etc.) and constraints (taking into account the different budgets and preferences of each user), and adjusts the first calendar itinerary information of this part of users to obtain the adjusted calendar itinerary information, which specifically includes the second calendar itinerary information, the third calendar itinerary information and the total calendar itinerary information. For example, the users with an associated relationship include user A, user B, and user C. For user A, if user A has sufficient permission, in addition to being able to obtain and view its own second calendar itinerary information, it can also view the third calendar itinerary information (including the second calendar itinerary information of user B or user C) and the total calendar itinerary information (including the calendar itinerary information of user A, user B, and user C). The total calendar itinerary information created by the method of the present application can not only take into account the personalized needs of each user, but also take into account the rationality of the itinerary arrangements of each associated user, so that it can meet the collaborative needs between multiple users.

Historical schedule data, analyze each of the historical schedule data to create a calendar portrait corresponding to each user

In some embodiments, as shown in FIG. 2, receiving constraint information and inputting the first calendar itinerary information, constraint information, and user association relationship corresponding to each user into the trained second neural network model includes:

Step S201: when the trained second neural network model detects that the first calendar itinerary information of multiple mutually associated users conflicts with the constraint information, determining a first user group and first itinerary adjustment information according to the conflict content, sending the first itinerary adjustment information to the first user group, and receiving feedback information from the first user group regarding the constraint information or the first itinerary adjustment information, adjusting the constraint information or the first calendar itinerary information of at least one user in the first user group based on the feedback information, and determining again whether the first calendar itinerary information of all users conflicts with the constraint information after the adjustment is completed;

Step S202: repeating the above steps until there is no conflict between the first calendar itinerary information of all users and the constraint information or until all users in the first user group are traversed.

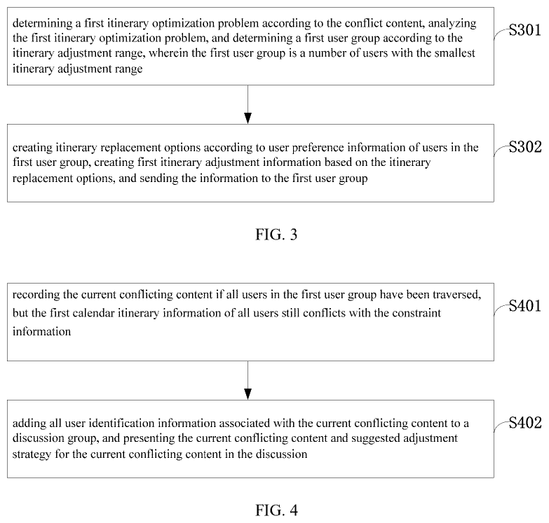

Further, as shown in FIG. 3, determining a first user group and first itinerary adjustment information according to the conflict content, and sending the first itinerary adjustment information to the first user group includes:

Step S301: determining a first itinerary optimization problem according to the conflict content, analyzing the first itinerary optimization problem, and determining a first user group according to the itinerary adjustment range, wherein the first user group is a number of users with the smallest itinerary adjustment range;

Step S302: creating itinerary replacement options according to user preference information of users in the first user group, creating first itinerary adjustment information based on the itinerary replacement options, and sending the information to the first user group.

In this embodiment, when it is detected that there is a conflict between the calendar itinerary information of a certain user and the constraint information, the first itinerary adjustment information may be created, a feedback may be sent to users in a specific group, asking these users whether they are willing to adjust their itineraries, and adjusting the first calendar itinerary information of the user according to the user's feedback information to determine whether there is a conflict again. Preferably, in order to save computing power and improve the adjustment speed, an equation will be established based on the constraint problem, and the first itinerary adjustment information will be sent to the user with the smallest adjustment range first. If the feedback result shows that the user does not accept the adjustment arrangement of the first itinerary adjustment information, the first itinerary adjustment information will be sent to the user with the next largest adjustment range, and so on, until the first calendar itinerary information of all users does not conflict with the constraint information or until all users in the first user group have been traversed.

Of course, in other embodiments, each user may be marked with a priority level, and each user may be scored each time the first user group needs to be determined. The score depends on the user's priority level and the adjustment range. The higher the user's priority level, the greater the influence of the user on a certain itinerary arrangement, and the lower the probability the user is adjusted. The smaller the user's adjustment range, the smaller the correction amount of the first calendar itinerary information and constraint condition information of all users from conflict to non-conflict if the user's itinerary is adjusted. This solution comprehensively determines the first user group by taking into account the importance of each user to a certain itinerary event and the adjustment range, which can make the adjustment of itinerary information more targeted and meet the needs of diverse application scenarios.

In some embodiments, as shown in FIG. 4, the method includes:

Step S401: recording the current conflicting content if all users in the first user group have been traversed, but the first calendar itinerary information of all users still conflicts with the constraint information;

Step S402: adding all user identification information associated with the current conflicting content to a discussion group, and presenting the current conflicting content and suggested adjustment strategy for the current conflicting content in the discussion.

In short, if all users in the first user group have been traversed completely, but the first calendar itinerary information of all users still conflicts with the constraint information, it means that there is something unreasonable about this itinerary arrangement. The reason may be that there are large discrepancies and distinctions in the preference information or choices of at least two users, and the itinerary arrangement cannot take care of all the users'needs. Therefore, with respect to this situation, the system will automatically establish a discussion group and add all users related to solving the conflict content to the discussion group so that multiple parties can discuss solutions in the discussion group. Conflict content refers to contradictory time points or itineraries, as well as the itinerary preferences of each user at this time point.

In some embodiments, the method also includes: receiving feedback from each user in the discussion group regarding the suggested adjustment strategy, and creating adjustment strategy confirmation information based on the feedback content, and after all relevant users in the discussion group have confirmed that it is correct, adjusting and updating the first calendar itinerary information of the relevant users based on the confirmed adjustment strategy confirmation information, thereby outputting the second calendar itinerary information that meets the constraint information through the second neural network model.

In some embodiments, the user permission information includes a first permission, a second permission, or a third permission, wherein the third permission has a higher priority than the second permission, and the second permission has a higher priority than the first permission;

Presenting any one or more of the second calendar itinerary information, the third calendar itinerary information or the total calendar itinerary information on the user end according to the user permission information corresponding to each user includes:
presenting the second calendar itinerary information corresponding to the user on the user end when the user permission information is the first permission;
presenting the second calendar itinerary information or the third calendar itinerary information corresponding to the user on the user end according to the received first itinerary switching instruction when the user permission information is the second permission;
presenting the second calendar itinerary information, the third calendar itinerary information or the total calendar itinerary information corresponding to the user on the user end according to the received second itinerary switching instruction when the user permission information is the third permission, and highlighting the calendar itinerary information corresponding to the current user in the total calendar itinerary information when the total calendar itinerary information is presented on the user end.

In short, for the total calendar itinerary information of individuals, related users and all users, different user permissions can be assigned to different users, and users with different permissions can view different types of calendar itinerary information on their own user ends. For example, during a family gathering, all family members can view each other's calendar itinerary information and calendar itinerary information. In the corporate business field, the company's grassroots employees are only granted the permission to view the second calendar itinerary information corresponding to their individuals, while the third calendar itinerary information or total calendar itinerary information can only be viewed by the company's middle and senior employees.

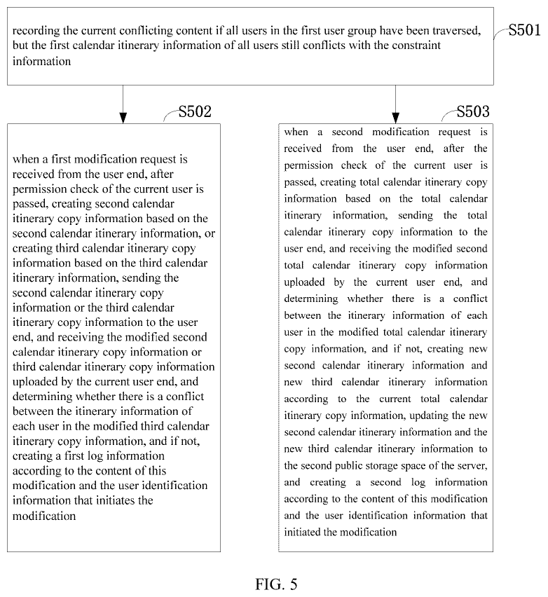

In some embodiments, as shown in FIG. 5, the method further includes:
Step S501: storing the created total calendar itinerary information in the first public storage space of the server, and storing the created second calendar itinerary information or third calendar itinerary information in the second public storage space of the server;
After step S501, it may proceed to step S502 as follows: when a first modification request is received from the user end, after permission check of the current user is passed, creating second calendar itinerary copy information based on the second calendar itinerary information, or creating third calendar itinerary copy information based on the third calendar itinerary information, sending the second calendar itinerary copy information or the third calendar itinerary copy information to the user end, and receiving the modified second calendar itinerary copy information or third calendar itinerary copy information uploaded by the current user end, and determining whether there is a conflict between the itinerary information of each user in the modified third calendar itinerary copy information, and if not, creating a first log information according to the content of this modification and the user identification information that initiates the modification;
After step S501, it may alternatively proceed to step S503 as follows: when a second modification request is received from the user end, after the permission check of the current user is passed, creating total calendar itinerary copy information based on the total calendar itinerary information, sending the total calendar itinerary copy information to the user end, and receiving the modified second total calendar itinerary copy information uploaded by the current user end, and determining whether there is a conflict between the itinerary information of each user in the modified total calendar itinerary copy information, and if not, creating new second calendar itinerary information and new third calendar itinerary information according to the current total calendar itinerary copy information, updating the new second calendar itinerary information and the new third calendar itinerary information to the second public storage space of the server, and creating a second log information according to the content of this modification and the user identification information that initiated the modification.

In this embodiment, the total calendar itinerary information is stored in a public storage space on the server end as a record of the calendar itinerary information of all associated users, and requires specific permissions to access, while the second calendar itinerary information or the third calendar itinerary information is stored separately in another public storage space on the server end. Generally, users can only obtain their own related second calendar itinerary information, and users with higher permissions can further access the third calendar itinerary information, or even the total calendar itinerary information.

In order to facilitate tracing, each time the calendar itinerary information is accessed, the server always creates and sends a corresponding copy to the user. If a user has a high level of permission, he may also modify the calendar itinerary information of other users. Specifically, he may directly retrieve the calendar itinerary information or the total calendar itinerary information of a user for modification. Of course, the second neural network model may verify in real time whether the modified itinerary meets the current constraint information, so as to remind the user who is exercising the modification permission whether he needs to further adjust the itinerary information or modify the current constraint information, so that the adjusted itinerary information meets the requirements of the constraint information. Further, for each modification of each user, the corresponding log information may be created for recording. In addition to recording the modified content, the log information may also record the identification information of the modifier, so as to facilitate tracing. The original calendar itinerary information is still stored in the first public storage space or the second public storage space of the server, so that it can be restored at any time when the user makes an error operation.

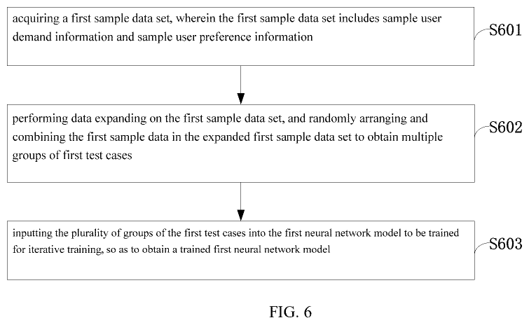

In some embodiments, as shown in FIG. 6, the first neural network model is trained according to the following method comprising:
Step S601: acquiring a first sample data set, wherein the first sample data set includes sample user demand information and sample user preference information;
Step S602: performing data expanding on the first sample data set, and randomly arranging and combining the first sample data in the expanded first sample data set to obtain multiple groups of first test cases;
Step S603: inputting the plurality of groups of the first test cases into the first neural network model to be trained for iterative training, so as to obtain a trained first neural network model;

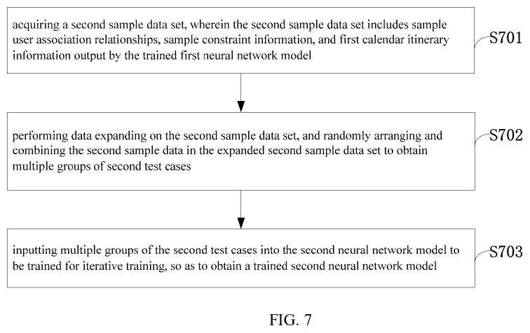

As shown in FIG. 7, the second neural network model is trained according to the following method comprising:
Step S701: acquiring a second sample data set, wherein the second sample data set includes sample user association relationships, sample constraint information, and first calendar itinerary information output by the trained first neural network model;
Step S702: performing data expanding on the second sample data set, and randomly arranging and combining the second sample data in the expanded second sample data set to obtain multiple groups of second test cases;
Step S703: inputting multiple groups of the second test cases into the second neural network model to be trained for iterative training, so as to obtain a trained second neural network model.

In this embodiment, the first neural network model or the second neural network model may be a convolutional neural network (CNN) or a recurrent neural network (RNN) and its variants (such as LSTM, GRU).

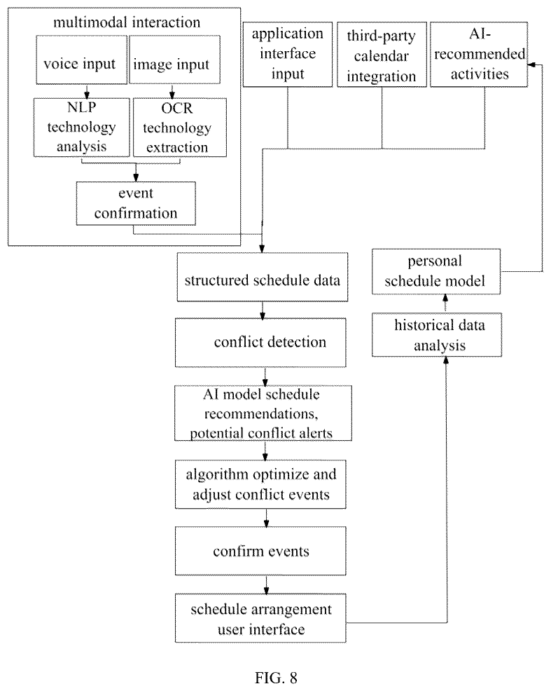

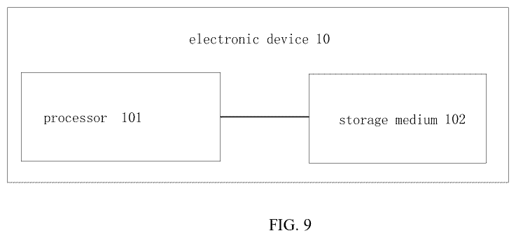

As shown in FIG. 8, in some embodiments, the present application also implements personalized schedule recommendations and conflict optimization by introducing AI algorithms as follows: constructing dynamic user portraits through the fusion of multimodal data (such as historical schedules, user preferences, and contextual data), and using deep reinforcement learning (PPO) to implement personalized schedule recommendations, specifically including: defining state space (user schedule status), action space (event insertion, adjustment), and reward function (time utilization, user satisfaction).

For conflict optimization, the present application models schedule conflicts as a dynamic multi-objective optimization problem, and dynamically adjusts schedules by combining reinforcement learning with meta-heuristic algorithms (such as adaptive genetic algorithms). Federated learning is introduced to protect user privacy, and performance is optimized collaboratively through edge reasoning and cloud training to achieve an efficient and intelligent solution for personalized recommendations and conflict optimization.

In addition, the present application also integrates multimodal interaction manners, including voice input or image input, when collecting user demand information or constraint information. Specifically, multimodal deep learning technology may be adopted to build an integrated interaction model for voice and image input. The voice input data is parsed through a pre-trained Transformer model (such as Whisper) to parse semantic information and extract time, place and event descriptions; the image input data is jointly processed by OCR and the visual Transformer (ViT) model to identify handwriting, printed text or scene features and match the schedule context. The present application innovatively introduces cross-modal alignment technology (such as CLIP) to create a unified semantic embedding space to achieve high-precision fusion and consistency verification of multimodal data. Combined with reinforcement learning to dynamically optimize the input parsing strategy, an edge-cloud collaborative architecture is deployed to achieve low-latency, high-reliability personalized schedule event creation.

The computational complexity of the above embodiment is as follows:
(1) Date and time parsing: complexity formula: 0(n), where n is the length of the string to be parsed;
(2) Time zone conversion: complexity formula: 0(1), constant time operation;
(3) Repeated rule calculation: complexity formula 0(m), where m is the number of rule matches;
(4) Comparison complexity: complexity formula 0(y), where y is the number of comparisons;
Overall complexity: T=0(n)+0(1)+0(m)+0(y).
Example: Calculate events for one year, cycling every day;
Time complexity: 0(n);
1. Among them, n is the total number of days in a year including leap years;
2. The operations in each cycle are constant time operations, so the complexity is linearly proportional to the number of days;
3. The total cycling process can be expressed as:
number of cycles n (number of days in a year);
the calculation operation for each cycle is 0(1);

The complexity of the entire cycle can be comprehensively expressed as:

$$T = 0 ( n ) \times 0 ( 1 ) = 0 ( n ) T = 0 ( n ) \times 0 ( 1 ) = 0 ( n ) .$$

In a second aspect, the present disclosure further provides a computer-readable storage medium having a computer program stored thereon, which, when executed by a processor, implements the multi-user interactive calendar management method based on artificial intelligence as described in the first aspect of the present disclosure.

The computer-readable storage medium may be a volatile memory or a non-volatile memory, or may include both volatile and non-volatile memories.

The non-volatile memory can be a read-only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disc, or a compact disc read-only memory (CD ROM); the magnetic surface memory can be a disk memory or a tape memory.

The volatile memory may be a random access memory (RAM), which is used as an external cache. By way of example but not limitation, many forms of RAM are available, such as static random access memory (SRAM), synchronous static random access memory (SSRAM), dynamic random access memory (DRAM), synchronous dynamic random access memory (SDRAM) , double data rate synchronous dynamic random access memory (DDRSDRAM), enhanced synchronous dynamic random access memory (ESDRAM), synchronous link dynamic random access memory (SLDRAM), direct memory bus random access memory (DRRAM). The computer-readable storage medium described in the embodiments of the present disclosure is intended to include these and any other suitable types of memory.

As shown in FIG. 9, in a third aspect, the present disclosure provides an electronic device 10, including a processor 101 and a storage medium 102, on which a computer program is stored. When the computer program is executed by the processor, the multi-user interactive calendar management method based on artificial intelligence as described in the first aspect of the present disclosure is implemented.

In some embodiments, the processor can be implemented by software, hardware, firmware or a combination thereof, and can use circuits, single or multiple application specific integrated circuits (Application Specific Integrated Circuit, ASIC), digital signal processors (Digital Signal Processor, DSP), digital signal processing devices (Digital Signal Processing Device, DSPD), programmable logic devices (Programmable Logic Device, PLD), field programmable gate arrays (Field Programmable Gate Array, FPGA), central processing units (Central Processing Unit, CPU), controllers, microcontrollers, at least one of microprocessors, so that the processor can execute some or all of the steps or any combination of the steps in The multi-user interactive calendar management method based on artificial intelligence described in the various embodiments of the present application.

Finally, it should be noted that although the above embodiments have been described in the specification and drawings of this application, this does not limit the scope of patent protection of this application. All technical solutions created by replacing or modifying equivalent structures or equivalent processes based on the essential concept of this application using the contents recorded in the specification and drawings of this application, as well as directly or indirectly implementing the technical solutions of the above embodiments in other related technical fields, all fall into the scope of patent protection of the present application.

What is claimed is:

1. A multi-user interactive calendar management method based on artificial intelligence, wherein, the method comprises the following steps:
receiving historical schedule data of multiple users, analyzing each of the historical schedule data respectively, and creating a calendar portrait corresponding to each user, wherein the calendar portrait includes user identification information, user preference information, user association relationship and user permission information;
receiving user demand information, inputting the user demand information and the user preference information corresponding to each user into a trained first neural network model, and outputting first calendar itinerary information corresponding to each user;
receiving constraint information, inputting the first calendar itinerary information corresponding to each user, the constraint information, and user association relationship into a trained second neural network model, and outputting second calendar itinerary information corresponding to each user, third calendar itinerary information of other users who have an association relationship with each user, and total calendar itinerary information, wherein the total calendar itinerary information includes the second calendar itinerary information and the third calendar itinerary information;
presenting any one or more of the second calendar itinerary information, the third calendar itinerary information and the total calendar itinerary information on the user end according to the user permission information corresponding to each user.

2. The multi-user interactive calendar management method based on artificial intelligence according to claim 1, wherein, receiving constraint information and inputting the first calendar itinerary information, the constraint information and user association relationship corresponding to each user into the trained second neural network model comprises:
when the trained second neural network model detects that the first calendar itinerary information of multiple mutually associated users conflicts with the constraint information, determining a first user group and first itinerary adjustment information according to the conflict content, sending the first itinerary adjustment information to the first user group, and receiving feedback information from the first user group regarding the constraint information or the first itinerary adjustment information, adjusting the constraint information or the first calendar itinerary information of at least one user in the first user group based on the feedback information, and after the adjustment is completed, determining again whether the first calendar itinerary information of all users conflicts with the constraint information;
repeating the above steps until there is no conflict between the first calendar itinerary information of all users and the constraint information or until all users in the first user group are traversed.

3. The multi-user interactive calendar management method based on artificial intelligence according to claim 2, wherein, determining the first user group and the first itinerary adjustment information according to the conflict content, and sending the first itinerary adjustment information to the first user group comprises:
determining a first itinerary optimization problem according to the conflict content, analyzing the first itinerary optimization problem, and determining a first user group according to the itinerary adjustment range, wherein the first user group is a number of users with the smallest itinerary adjustment range;
creating itinerary replacement options according to user preference information of users in the first user group, creating and sending first itinerary adjustment information based on the itinerary replacement options to the first user group.

4. The multi-user interactive calendar management method based on artificial intelligence according to claim 2, wherein, the method comprises:
recording current conflict content if all users in the first user group have been traversed, but the first calendar itinerary information of all users still conflicts with the constraint information;
adding all user identification information associated with the current conflicting content to a discussion group, and presenting the current conflicting content and the suggested adjustment strategy for the current conflicting content in the discussion.

5. The multi-user interactive calendar management method based on artificial intelligence according to claim 1, wherein the user permission information includes a first permission, a second permission or a third permission, the third permission has a higher priority than the second permission, and the second permission has a higher priority than the first permission;
presenting any one or more of the second calendar itinerary information, the third calendar itinerary information and the total calendar itinerary information on the user end according to the user permission information corresponding to each user includes:
when the user permission information is the first permission, presenting the second calendar itinerary information corresponding to the user on the user end;
when the user permission information is the second permission, presenting the second calendar itinerary information or the third calendar itinerary information corresponding to the user on the user end according to the received first itinerary switching instruction;
when the user permission information is the third permission, presenting the second calendar itinerary information, the third calendar itinerary information or the total calendar itinerary information corresponding to the user on the user end according to the received second itinerary switching instruction, and when the total calendar itinerary information is presented on the user end, highlighting the calendar itinerary information corresponding to the current user in the total calendar itinerary information.

6. The multi-user interactive calendar management method based on artificial intelligence according to claim 1, wherein the user demand information includes any one or more of personnel quantity information, budget information, time span information, geographic location information, activity theme type information, and activity priority information;
the constraint information includes any one or more of time constraints, resource-related constraints or itinerary theme constraints.

7. The multi-user interactive calendar management method based on artificial intelligence according to claim 1, wherein the method further comprises:
storing the created total calender itinerary information in a first public storage space of the server, and storing the created second calendar itinerary information or third calendar itinerary information in a second public storage space of the server end;
when receiving a first modification request from the user end, after the permission check of the current user is passed, creating second calendar itinerary copy information based on the second calendar itinerary information, or creating third calendar itinerary copy information based on the third calendar itinerary information, sending the second calendar itinerary copy information or the third calendar itinerary copy information to the user end, and receiving the modified second calendar itinerary copy information or the third calendar itinerary copy information uploaded by the current user end, determining whether there is a conflict in itinerary information of each user in the modified third calendar itinerary copy information, and if not, creating first log information according to the content of this modification and the user identification information initiating the modification;
when receiving a second modification request from the user end, after the permission check of the current user is passed, creating a total calendar itinerary copy information based on the total calendar itinerary information, sending the total calendar itinerary copy information to the user end, and receiving the modified second total calendar itinerary copy information uploaded by the current user end, and determining whether there is a conflict in the itinerary information of each user in the modified total calendar itinerary copy information, if not, creating new second calendar itinerary information and new third calendar itinerary information according to the current total calendar itinerary copy information, updating the new second calendar itinerary information and new third calendar itinerary information to the second public storage space of the server end, and creating second log information according to the content of this modification and the user identification information that initiated the modification.

8. The multi-user interactive calendar management method based on artificial intelligence according to claim 1, wherein the first neural network model is trained according to the following method comprising:
acquiring a first sample data set, where the first sample data set includes sample user demand information and sample user preference information;
performing data expansion on the first sample data set, and randomly arranging and combining the first sample data in the expanded first sample data set to obtain multiple groups of first test cases;
inputting the plurality of groups of the first test cases into the first neural network model to be trained for iterative training to obtain a trained first neural network model;
the second neural network model is trained according to the following method comprising:
acquiring a second sample data set, where the second sample data set includes sample user association relationships, sample constraint information, and first calendar itinerary information output by the trained first neural network model;
performing data expansion on the second sample data set, and randomly arranging and combining the second sample data in the expanded second sample data set to obtain multiple groups of second test cases;
inputting multiple groups of the second test cases into the second neural network model to be trained for iterative training to obtain a trained second neural network model.

9. A computer-readable storage medium having a computer program stored thereon, wherein when the program is executed by a processor, the multi-user interactive calendar management method based on artificial intelligence as described in claim 1 is implemented.

10. An electronic device having a computer program stored thereon, the electronic device comprising a processor and a storage medium, wherein the storage medium stores a computer program, and when the computer program is executed by the processor, the multi-user interactive calendar management method based on artificial intelligence as described in claim 1 is implemented.
